(19) United States
(12) Patent Application Publication
(10) Pub. No.: US 2008/0037843 A1
(43) Pub. Date: Feb. 14, 2008

(54) Image segmentation for DRR generation and image registration

(75) Inventors: Dongshan Fu, Santa Clara, CA (US); Hongwu Wang, Milpitas, CA (US); Calvin R. Maurer, Mountain View, CA (US)

Correspondence Address: BLAKELY SOKOLOFF TAYLOR & ZAFMAN, 1279 OAKMEAD PARKWAY, SUNNYVALE, CA, 94085-4040, US

(73) Assignee: Accuray Incorporated

(21) Appl. No.: 11/502,699

(22) Filed: Aug. 11, 2006

(51) Int. Cl. G06K 9/00; G06K 9/34

(52) U.S. Cl. 382/128; 382/173

(57) ABSTRACT

A system, method and apparatus for enhancing 2D-3D registration with digitally reconstructed radiographs derived from segmented spine data.

### TECHNICAL FIELD

Embodiments of the invention are related to image-guided radiation treatment systems and, in particular, to the use of segmentation to improve the utility of digitally reconstructed radiographs in image-guided radiation treatment systems.

### BACKGROUND

Image-guided radiosurgery and radiotherapy systems (image-guided radiation treatment systems, collectively) are radiation treatment systems that use external radiation beams to treat pathological anatomies (e.g., tumors, lesions, vascular malformations, nerve disorders, etc.) by delivering a prescribed dose of radiation (e.g., x-rays or gamma rays) to the pathological anatomy while minimizing radiation exposure to surrounding tissue and critical anatomical structures (e.g., the spinal cord). Both radiosurgery and radiotherapy are designed to necrotize or damage the pathological anatomy while sparing healthy tissue and the critical structures. Radiotherapy is characterized by a low radiation dose per treatment (1-2 Gray per treatment), and many treatments (e.g., 30 to 45 treatments). Radiosurgery is characterized by a relatively high radiation dose (typically 5 Gray or more per treatment) in one to five treatments (1 Gray equals one joule per kilogram).

In both radiotherapy and radiosurgery, the radiation dose is delivered to the site of the pathological anatomy from multiple angles. As the angle of each radiation beam is different, each beam can intersect a target region occupied by the pathological anatomy, while passing through different regions of healthy tissue on its way to and from the target region. As a result, the cumulative radiation dose in the target region is high and the average radiation dose to healthy tissue and critical structures is low.

In contrast to frame-based radiotherapy and radiosurgery systems (where a rigid and invasive frame is fixed to the patient to immobilize the patient throughout diagnostic imaging, treatment planning and subsequent treatment delivery), image-guided radiosurgery and radiotherapy systems eliminate the need for invasive frame fixation by tracking patient pose (position and orientation) during treatment. In addition, while frame-based systems are generally limited to intracranial therapy, image-guided systems are not so limited.

Image-guided radiotherapy and radiosurgery systems include gantry-based systems and robotic-based systems. In gantry-based systems, a radiation source is attached to a gantry that moves around a center of rotation (isocenter) in a single plane. Each time a radiation beam is delivered during treatment, the axis of the beam passes through the isocenter. Treatment angles are therefore limited by the rotation range of the radiation source and the degrees of freedom of a patient positioning system. In robotic-based systems, such as the CyberKnife® Stereotactic Radiosurgery System manufactured by Accuray, Inc. of California, the radiation source is not constrained to a single plane of rotation, having five or more degrees of freedom.

In conventional image-guided radiation treatment systems, patient tracking during treatment is accomplished by comparing two-dimensional (2D) in-treatment x-ray images of the patient to 2D digitally reconstructed radiographs (DRRs) derived from the three dimensional (3D) pre-treatment imaging data that is used for diagnosis and treatment planning. The pre-treatment imaging data may be computed tomography (CT) data, magnetic resonance imaging (MI) data, positron emission tomography (PET) data or 3D rotational angiography (3DRA), for example. Typically, the in-treatment x-ray imaging system is stereoscopic, producing images of the patient from two or more different points of view (e.g., orthogonal), and a corresponding DRR is generated for each point of view.

A DRR is a synthetic x-ray image generated by casting (mathematically projecting) rays through a 3D image, simulating the geometry of the in-treatment x-ray imaging system. The resulting DRR then has the same scale and point of view as the in-treatment x-ray imaging system. To generate a DRR, the 3D imaging data is divided into voxels (volume elements) and each voxel is assigned an attenuation (loss) value derived from the 3D imaging data. The relative intensity of each pixel in a DRR is then the summation of the voxel losses for each ray projected through the 3D image. Different patient poses are simulated by performing 3D transformations (rotations and translations) on the 3D imaging data before the DRR is generated.

In some image-guided systems, the 3D transformations and DRR generation are performed iteratively in real time, during treatment. In other systems, such as the CyberKnife® Stereotactic Radiosurgery System manufactured by Accuray, Inc. of Sunnyvale, Calif., a set of DRRs (in each projection) corresponding to an expected range of patient poses is pre-computed before treatment begins.

Each comparison of an in-treatment x-ray image with a DRR produces a similarity measure (e.g., cross correlation, entropy, mutual information, gradient correlation, pattern intensity, gradient difference, image intensity gradients) that can be used to search for a 3D transformation that produces a DRR with a higher similarity measure to the in-treatment x-ray image (or to search directly for a pre-computed DRR as described above). When the similarity measure is sufficiently maximized, the 3D transformation corresponding to the DRR can be used to align the 3D coordinate system of the treatment plan with the 3D coordinate system of the treatment delivery system, to conform the relative positions of the radiation source and the patient to the treatment plan. In the case of pre-computed DRRs, the maximum similarity measure may be used to compute a differential 3D transformation between the two closest DRRs. FIG. 1 illustrates the process described above for the case of in-treatment DRR generation.

One limiting factor in the accuracy of the registration and tracking algorithms is the quality of the DRRs derived from the 3D imaging data. Three-dimensional scanning procedures (such as CT or MRI scans, for example) are time-consuming, often requiring many minutes. Ideally, for the best image quality, the patient should remain absolutely still during the procedure, but this is not always possible. In particular, patients cannot stop breathing and often cannot hold their breath for extended periods. Elderly patients or others with compromised respiratory systems may be unable to breath-hold at all. When the spine is being imaged, for example, breathing creates motion artifacts in the 3D imaging data because body structures such as the lungs, ribs and diaphragm are in motion relative to the spine. When the 3D imaging data is later used to generate DRRs, the motion artifacts in 3D manifest as image artifacts in 2D including loss of true detail and the presence of false detail and noise in the DRR, which reduce the sensitivity of the similarity measure to differences between the DRRs and the x-ray images. Additionally, even in the absence of motion artifacts, the mere presence of other bony structures and soft tissues may create sufficient image artifacts in the DRRs to degrade the image comparison.

### BRIEF DESCRIPTION OF THE DRAWINGS

The present invention is illustrated by way of example, and not by limitation, in the figures of the accompanying drawings in which:

FIG. 1 illustrates 2D-3D registration in a conventional image-guided radiation treatment system.

FIG. 2 illustrates an image-guided robotic radiosurgery system in one embodiment;

FIG. 3 illustrates a coordinate systems representation in one embodiment;

FIGS. 4A-4D illustrate 2D-2D registration in one embodiment;

FIG. 5A and 5B are flowcharts illustrating workflow in conventional image-guided radiation treatment systems;

FIG. 6A is a flowchart illustrating workflow in one embodiment;

FIG. 6B is a flowchart illustrating workflow in an alternative embodiment;

FIG. 7 illustrates a geometrical representation of a volume of interest in one embodiment;

FIG. 8 illustrates a volume representation of a volume of interest in one embodiment;

FIG. 9 illustrates a segmentation tool in one embodiment;

FIGS. 10A and 10B illustrate contouring in one embodiment;

FIGS. 11A and 11B are DRRs in two projections from unsegmented 3D image data illustrating motion artifacts;

FIGS. 12A and 12B are DRRs in the two projections of FIGS. 11A and 11B from segmented 3D image data in one embodiment;

FIGS. 13A and 13B are DRRs in two projections from unsegmented 3D image data illustrating bony and soft tissue artifacts;

FIGS. 14A and 14B are DRRs in the two projections of FIGS. 13A and 13B from segmented 3D image data in one embodiment;

FIG. 15 is a flowchart illustrating a method in one embodiment; and

FIG. 16 is a block diagram illustrating a system in which embodiments of the invention may be implemented.

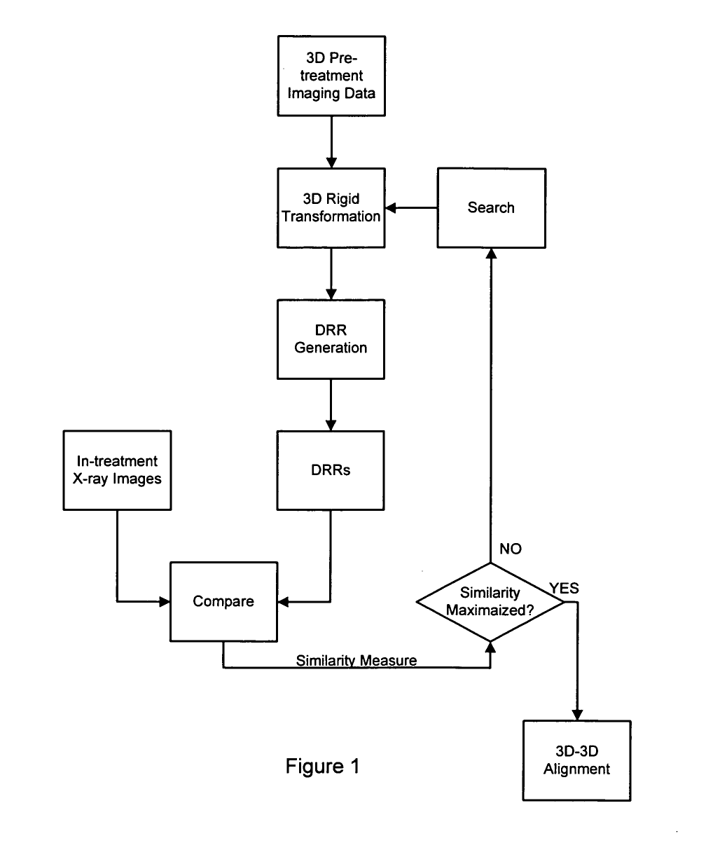

### DETAILED DESCRIPTION

In the following description, numerous specific details are set forth such as examples of specific components, devices, methods, etc., in order to provide a thorough understanding of embodiments of the present invention. It will be apparent, however, to one skilled in the art that these specific details need not be employed to practice embodiments of the present invention. In other instances, well-known materials or methods have not been described in detail in order to avoid unnecessarily obscuring embodiments of the present invention. The term “x-ray image” as used herein may mean a visible x-ray image (e.g., displayed on a video screen) or a digital representation of an x-ray image (e.g., a file corresponding to the pixel output of an x-ray detector). The term “in-treatment image” as used herein may refer to images captured at any point in time during a treatment delivery phase of a radiosurgery or radiotherapy procedure, which may include times when the radiation source is either on or off. From time to time, for convenience of description, CT imaging data may be used herein as an exemplary 3D imaging modality. It will be appreciated that data from any type of 3D imaging modality, such as CT data, MRI data, PET data, 3DRA data or the like, may also be used in various embodiments of the invention.

Unless stated otherwise as apparent from the following discussion, it will be appreciated that terms such as “segmenting,” “generating,” “registering,” “determining,” “aligning,” “positioning,” “processing,” “computing,” “selecting,” “estimating” “tracking” or the like may refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices. Embodiments of the methods described herein may be implemented using computer software. If written in a programming language conforming to a recognized standard, sequences of instructions designed to implement the methods can be compiled for execution on a variety of hardware platforms and for interface to a variety of operating systems. In addition, embodiments of the present invention are not described with reference to any particular programming language. It will be appreciated that a variety of programming languages may be used to implement embodiments of the present invention.

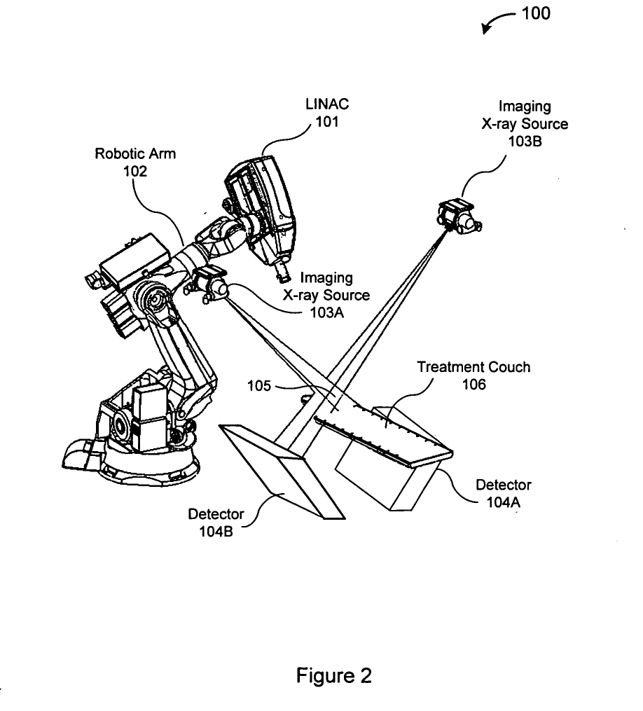

FIG. 2 illustrates the configuration of an image-guided, robotic-based radiation treatment system 100, such as the CyberKnife® Stereotactic Radiosurgery System manufactured by Accuray, Inc. of Sunnyvale, Calif. In FIG. 2, the radiation treatment source is a linear accelerator (LINAC) 101 mounted on the end of a robotic arm 102 having multiple (e.g., 5 or more) degrees of freedom in order to position the LINAC 101 to irradiate a pathological anatomy (target region or volume) with beams delivered from many angles, in many planes, in an operating volume around the patient. Treatment may involve beam paths with a single isocenter, multiple isocenters, or with a non-isocentric approach.

The treatment delivery system of FIG. 2 includes an in-treatment imaging system, which may include x-ray sources 103A and 103B and x-ray detectors (imagers) 104A and 104B. The two x-ray sources 103A and 103B may be mounted in fixed positions on the ceiling of an operating room and may be aligned to project imaging x-ray beams from two different angular positions (e.g., separated by 90 degrees) to intersect at a machine isocenter 105 (which provides a reference point for positioning the patient on a treatment couch 106 during treatment) and to illuminate imaging planes of respective detectors 104A and 104B after passing through the patient. In other embodiments, system 100 may include more or less than two x-ray sources and more or less than two detectors, and any of the detectors may be movable rather than fixed. In yet other embodiments, the positions of the x-ray sources and the detectors may be interchanged.

The detectors 104A and 104B may be fabricated from a scintillating material that converts the x-rays to visible light (e.g., amorphous silicon), and an array of CMOS (complementary metal oxide silicon) or CCD (charge-coupled device) imaging cells that convert the light to a digital image that can be compared with the reference images during the registration process.

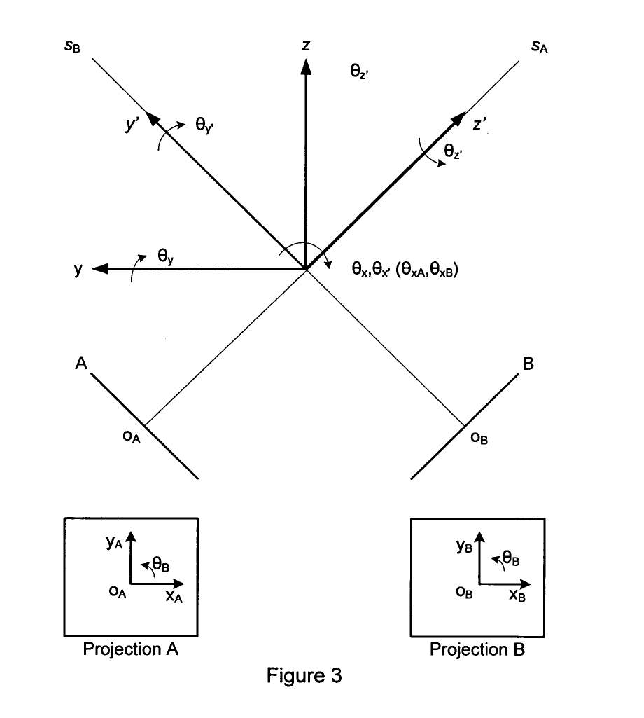

FIG. 3 illustrates geometric relationships among the 3D coordinate system of a treatment delivery system (such as treatment delivery system 100), the 2D coordinate system of an in-treatment imaging system (such as the in-treatment imaging system in treatment delivery system 100) and the 3D coordinate system of a 3D image (such as a pre-treatment CT image, for example). In FIG. 3, the coordinate system xyz (where x is normal to the plane of FIG. 3) associated with the 3D image, the coordinate system x′y′z′ (where x′ is normal to the plane of FIG. 3) is associated with the treatment delivery system, and the projections A and B are associated with the in-treatment imaging system where S_{A} and S_{B} represent x-ray sources (such as x-ray sources 103A and 103B) and O_{A} and O_{B} are the centers of the imaging planes of x-ray detectors (such as x-ray detectors 104A and 104B). In FIG. 3, the projections A and B are viewed from the directions O_{A}S_{A} and O_{B}S_{B}, respectively.

A 3D transformation may be defined from coordinate system xyz to coordinate system x′y′z′ in terms of three translations (Δx, Δy, Δz) and three rotations (Δθₓ, Δθ_{y}, Δθ_{z}) as illustrated in FIG. 3. Conversely, a 3D transformation may be defined from coordinate system x′y′z′ to coordinate system xyz in terms of three translations (Δx′, Δy′, Δz′) and three rotations (Δθ_{x′}, Δθ_{y′}, Δθ_{z′}). The direction of axis x_{A} in the coordinates of projection A is opposite to that of axis x in the 3D image coordinate system. The direction of axis x_{B} in the coordinates of projection B is the same as that of axis x in the 3D image coordinate system. A 3D rigid transformation between the two 3D coordinate systems can be derived from basic trigonometry as:

x=x′, y=(y′−z′)/√2, z=(y′+z′)/√2,

θₓ=θ_{x′}, θ_{y}=(θ_{y′}−θ_{z′})/√2, θ_{z}=(θ_{y′}+θ_{z′})/√2. (1)

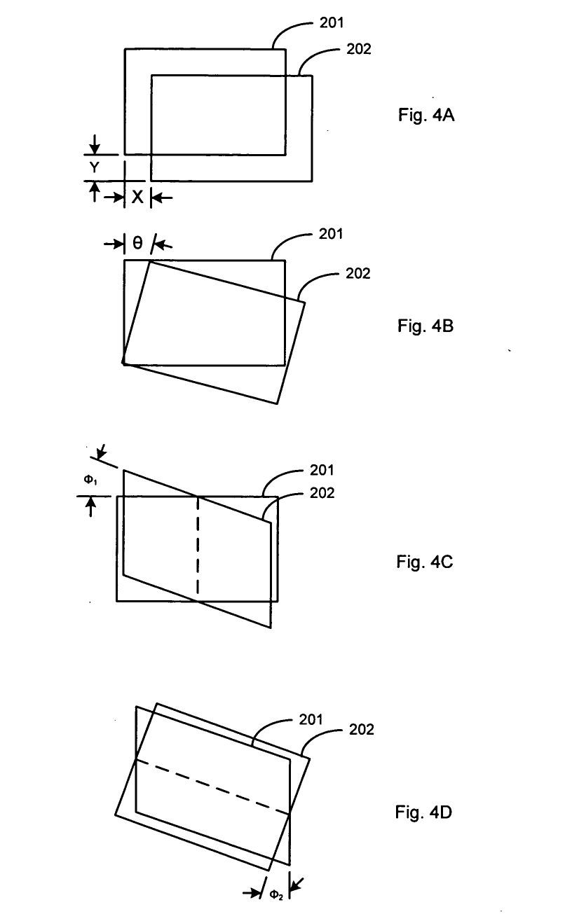

In the 2D coordinate system (x_{A}y_{A}) for projection A, the 3D rigid transformation is decomposed into the in-plane transformation (x_{A},y_{A},θ_{A}) and two out-of-plane rotations (θₓ_{_{A}},θ_{y′}). Similarly, in the 2D coordinate system (x_{B}y_{B}) for projection B, the decomposition consists of the in-plane transformation (x_{B},y_{B},θ_{B}) and two out-of-plane rotations (θₓ_{_{B}},θ_{z′}). FIGS. 4A-4D illustrate the in-plane transformations and out-of-plane rotations described herein, where a 2D x-ray image is represented by plane 201 and the 2D DRR is represented by plane 201. The 3D rigid transformation of equation (1) may be simplified by noting that the use of two projections over-constrains the solution to the six parameters of the 3D rigid transformation. The translation x_{A} in projection A is the same parameter as x_{B} in projection B, and the out-of-plane rotation θₓ_{_{A}} in projection A is the same as θₓ_{_{B}} in projection B. If α_{A} and α_{B} are geometric amplification factors (e.g., scale factors related to source-to-patient and patient-to-detector distances) for projections A and B, respectively, then the translations between the coordinate system (x′y′z′) and the 2D coordinate systems have the following relationships:

x′=(α_{B}x_{B}−α_{A}x_{A})/2, y′=α_{A}y_{A}, z′=α_{B}y_{B}. (2)

For projection A, given a set of DRR images that correspond to different combinations of the two out-of-plane rotations (θₓ_{_{A}},θ_{y′}), the 2D in-plane transformation (x_{A},y_{A},θ_{A}) may be estimated by a 2D to 2D image comparison, and the two out-of-plane rotations (θₓ_{_{A}},θ_{y′}) may be calculated by best matching the x-ray image to the set of DRR images as described below, using similarity measures. Likewise, the same process may be used to solve the 2D in-plane transformation (x_{B},y_{B},θ_{B}) and the out-of-plane rotations (θₓ_{_{B}},θ_{z′}) for the projection B. As described below, the in-plane transformation and out-of-plane rotations may be obtained by registration between the x-ray image and the set of DRR images, independently for both projection A and projection B. When a DRR image with a matching out-of-plane rotation is identified, the in-plane rotation and the out-of-plane rotation have the following relations:

θ_{y′}=θ_{B}, θ_{z′},=θ_{A}. (3)

If the out-of-plane rotation θ_{y′} is ignored in the set of reference DRR images for projection A, the in-plane transformation can be approximately described by x_{A},y_{A},θ_{A}) when θ_{y′} is small (e.g., less than 5⁰). Once this simplifying assumption is made, and given the set of reference DRR images which correspond to various out-of-plane rotations θₓ_{_{A}}, the in-plane transformation (x_{A},y_{A},θ_{A}) and the out-of-plane rotation θₓ_{_{A}} may be solved by one or more multi-phase registration methods as described in described in U.S. patent application Ser. No. 10/880486, titled “Fiducial-less Tracking with Non-rigid Image Registration,” filed Jun. 30, 2004 and in U.S. patent application Ser. No. 10/881208, titled “Image Enhancement Method and System for Fiducial-less Tracking of Treatment Targets,” filed Jun. 30, 2004, both of which are incorporated herein by reference. A corresponding simplification may be made for projection B. In one embodiment, the range of out-of-plane rotations defined for the reference DRR images may be limited to approximately ±5⁰ because out-of-plane rotations may be expected to be small after an initial patient alignment.

Given the results (x_{A},y_{A},θ_{A},θₓ_{_{A}}) in projection A and (x_{B},y_{B},θ_{B}, θₓ_{_{B}}) in projection B, the approximation of the 3D rigid transformation in the 3D image coordinate system may be obtained using the following expressions

x=(−α_{A}x_{A}+α_{B}x_{B})/2, y=(α_{A}y_{A}−α_{B}y_{B})/√2, z=(α_{A}y_{A}+α_{B}y_{B})/√2,

θₓ=(θₓ_{_{A}}+θₓ_{_{B}})/2, θ_{y}=(θ_{B}−θ_{A})/√2, θ_{z}=(θ_{B}+θ_{A})/√2. (4)

Thus, the two projections may be completely defined by the two sets of four parameters (x_{A},y_{A},θ_{A},θₓ_{_{A}}) and (x_{B}, y_{B},θ_{B},θₓ_{_{B}}). Similarity measures may be defined for each projection as functions of the respective parameters: S_{A}=f(x_{A},y_{A},θ_{A},θₓ_{_{A}}) and S_{B}=f(x_{B},y_{B},θ_{B},θₓ_{_{B}}). However, the total number of parameters needed to define the two projections jointly may be reduced to six by noting first that,

θₓ_{_{A}}=θₓ_{_{B}}=θₓ. (4)

Then, given the geometric amplification factors α_{A} and α_{B}, for projections A and B, respectively, the translations between the coordinate system (x′y′z′) and the 2D projection coordinate systems have the following relationships:

x′=−α_{A}x_{A}=α_{B}x_{B}, y′=α_{A}, y_{A}, z′=α_{B}y_{B} (5)

Substituting the foregoing equivalences into equation set (1) yields:

x=−α_{A}x_{A}=α_{B}x_{B}, y=(α_{A}y_{A}−α_{B}y_{B})/√2, z=(α_{A}y_{A}+α_{B}y_{B})/√2,

θₓ=θₓ_{_{A}}=θₓ_{_{B}}, θ_{y}=(θ_{B}−θ_{A})/√2, θ_{z}=(θ_{B}+θ_{A})/√2. (6).

Therefore, given a pair of DRRs and a pair of X-ray images in two projections, a combined similarity measure Sₜₒₜₐₗ=S_{A}+S_{B}=f(x,y_{A},y_{B},θₓ,θ_{A},θ_{B}) may be globally maximized by searching either in two four-parameter search spaces or in one six-parameter search space. Subsequently, the registration results may be mapped to the coordinate system of the treatment delivery system using equation set (6).

The foregoing description is intended to provide an understanding of the relationships between 3D pre-treatment imaging, 3D rigid transformations, DRRs and in-treatment x-ray images in one exemplary image-guided radiation treatment system in which embodiments of the present invention may be implemented. However, it will be appreciated that embodiments of the present invention may also be implemented in other types of radiation treatment systems, including gantry-type image-guided radiation treatment systems and/or radiation treatment systems that generate DRR images in real-time or near real-time during treatment.

Medical image segmentation is the process of partitioning a 3D medical image (such as a CT, MRI, PET or 3DRA image) into regions that are homogeneous with respect to one or more characteristics or features (e.g., tissue type, density). In radiation treatment systems (including both frame-based and image-guided), segmentation is a critical step in treatment planning where the boundaries and volumes of a targeted pathological anatomy (e.g., a tumor or lesion) and critical anatomical structures (e.g., spinal chord) are defined and mapped into the treatment plan. The precision of the segmentation is critical to obtaining a high degree of conformality and homogeneity in the radiation dose during treatment of the pathological anatomy while sparing healthy tissue from unnecessary radiation.

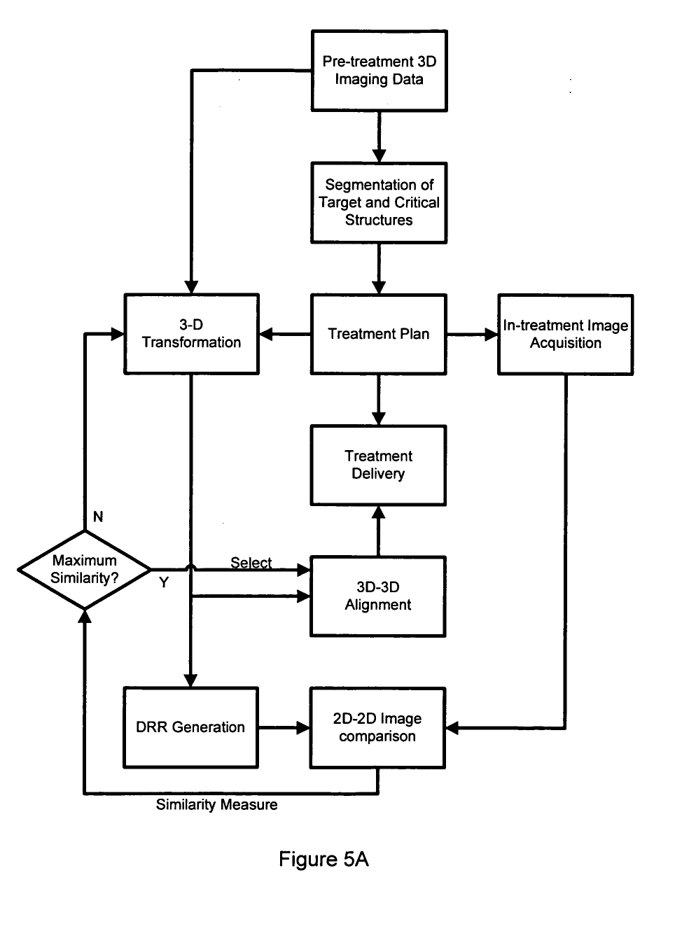

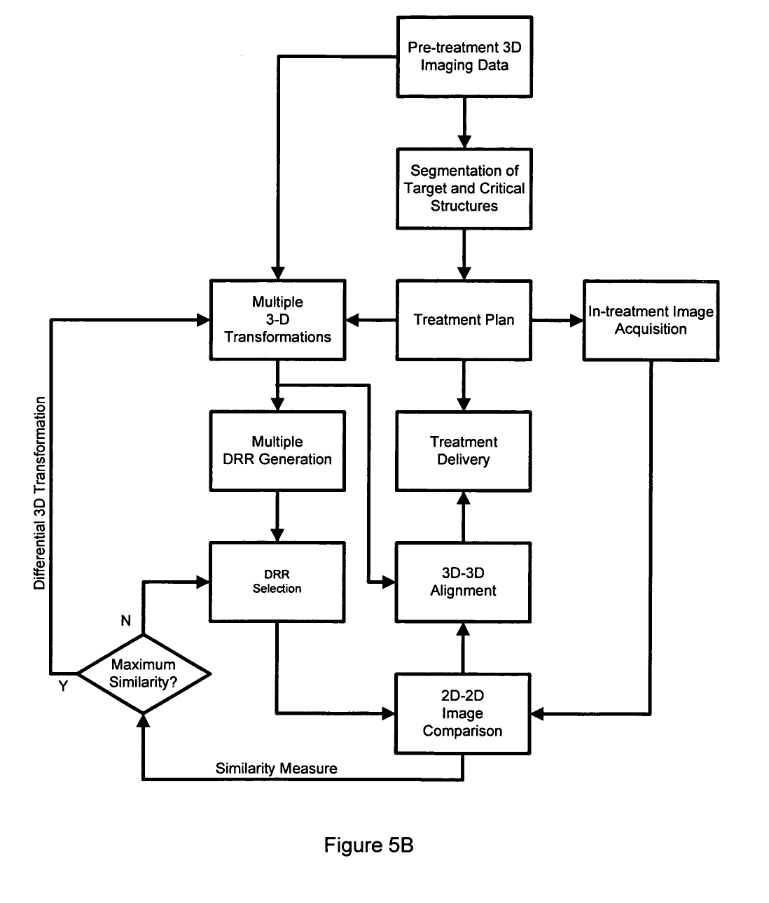

In conventional image-guided radiation treatment systems, the 3D imaging data used for image segmentation during treatment planning is also used for DRR generation. FIG. 5A illustrates work flow in a conventional image-guided radiation treatment system that generates DRR images during treatment, as described above. As illustrated in FIG. 5A, image segmentation and DRR generation are performed in different paths for treatment planning and treatment delivery. As illustrated in FIG. 5A, after the pre-treatment 3D imaging data is generated, image segmentation is used to differentiate the targeted pathological anatomy and critical anatomical structures to be avoided (e.g., the spinal cord). The results of the image segmentation are used in treatment planning to plan the delivery of radiation to the pathological anatomy.

The DRRs, however, are generated from 3D rigid transformations of the pre-segmentation 3D imaging data, which may include motion artifacts and other artifacts as described above. At the time of treatment, the 2D in-treatment x-ray images are compared with the 2D DRRs and the results of the comparison (a similarity measure as described above) are used iteratively to find a 3D rigid transformation of the 3D imaging data that produces DRRs most similar to the in-treatment x-ray images. When the similarity measure is maximized, the corresponding 3D rigid transformation is selected to align the coordinate system of the 3D imaging data with the 3D coordinate system of the treatment delivery system (e.g., by moving the radiation source and/or the patient).

FIG. 5B illustrates work flow in an image-guided radiation treatment system that generates DRR images before treatment, as described above. The work flow in FIG. 5B is the same as the work flow of FIG. 5A in all respects except that the results of the 2D-2D image comparisons are used to select from the pre-computed DRRs rather than to drive a 3D transformation function. In FIG. 5B, once the maximum similarity measure is found (based on the best-matching pre-computed DRRs), a 3D transformation may be extrapolated or interpolated from the DRRs for the 3D-3D alignment process. Here again, however, the DRRs are generated from 3D rigid transformations of the pre-segmentation 3D imaging data.

The methods and algorithms used to compare DRRs with in-treatment x-ray images and to compute similarity measures can be very robust and are capable of tracking both rigid and non-rigid (deformable) anatomical structures, such as the spine, without implanted fiducial markers. For non-rigid and/or deformable anatomical structures, such as the spine, registration and tracking are complicated by irreducible differences between DRRs derived from pre-treatment imaging and the x-ray images obtained during treatment (e.g., reflecting spinal torsion or flexing relative to the patient's pose during pre-treatment imaging). Methods for computing average rigid transformation parameters from such images have been developed to address the registration and tracking of non-rigid bodies. Such methods, including the calculation of vector displacement fields between DRRs and in-treatment x-ray images and 2D-2D registration and 2D-3D registration and tracking methods, are described in detail in U.S. patent application Ser. No. 10/880486 and in U.S. patent application Ser. No. 10/881208. However, to the extent that DRRs are generated from unsegmented 3D imaging data and contain false details or lack true details, any similarity measure computed between a DRR image and an in-treatment x-ray image will have a lowered sensitivity to image differences.

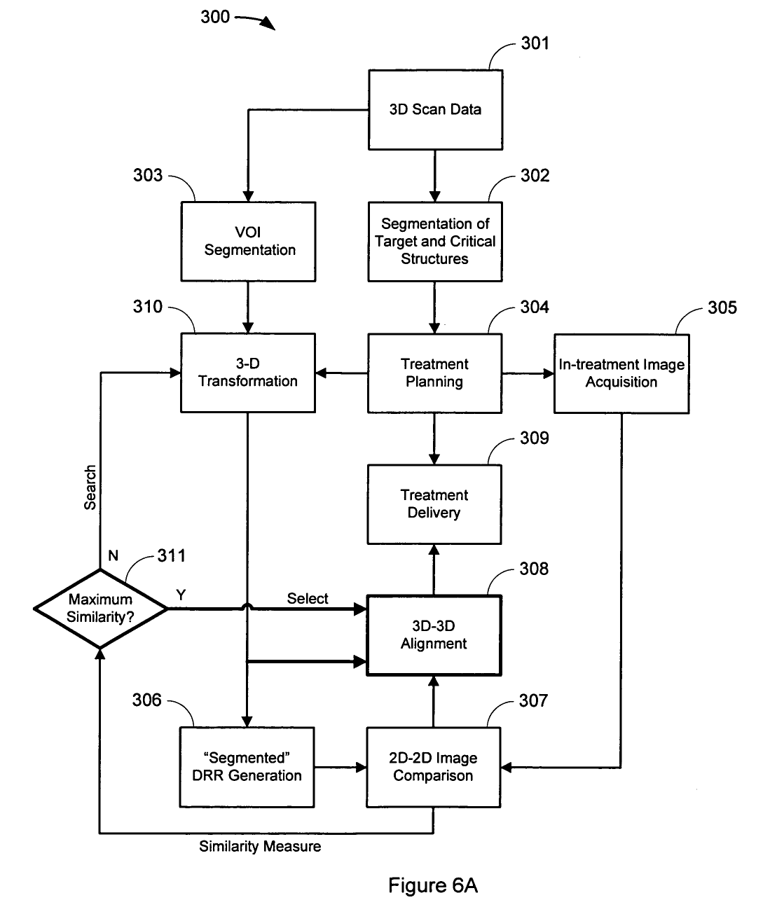

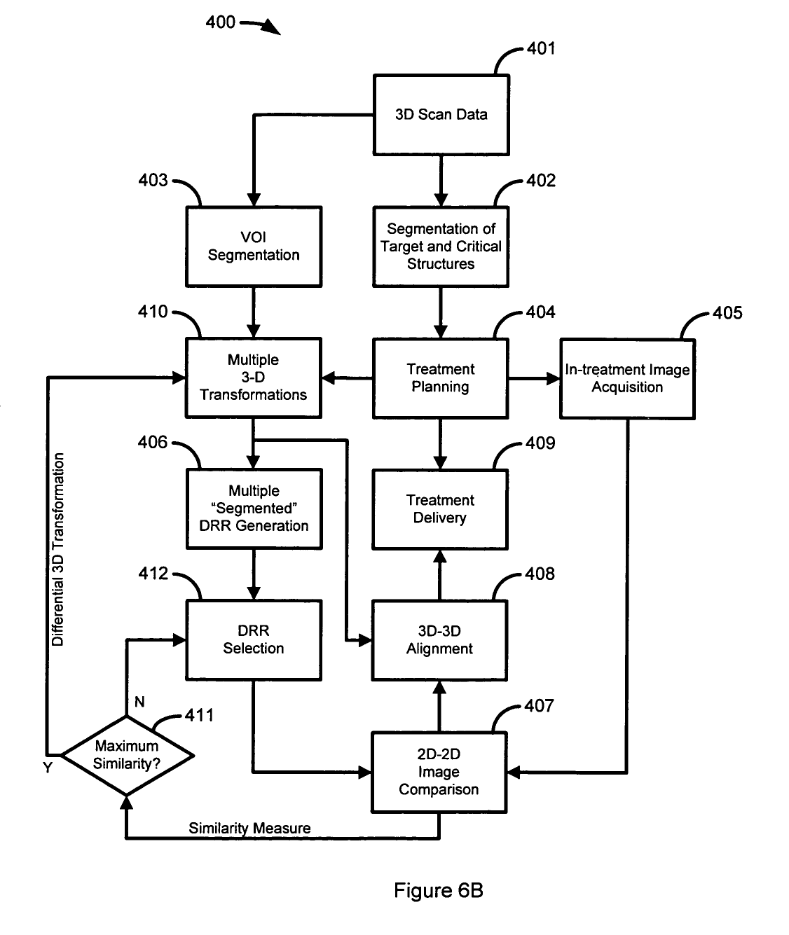

FIG. 6A illustrates a method 300 in one embodiment showing how image segmentation may be used, in a radiation treatment system generating real-time DRRs, to remove undesirable artifacts from 3D imaging data before DRR generation. In FIG. 6A, 3D imaging data is obtained in the conventional manner (e.g., CT, MRI, PET, 3DRA, etc.) in operation 301. In operation 302, the 3D imaging data is segmented to delineate a targeted pathological anatomy (e.g., a spinal tumor or lesion) and critical anatomical structures for treatment planning purposes. In operation 303, a volume of interest (VOI) of the 3D imaging data is segmented for DRR generation. The volume of interest may include an anatomical structure, such as the spine, and may also include some immediately adjacent tissue and may have contours (e.g., cylindrical contours) that are easy to define, either manually or automatically (e.g., using a medical imaging contour tool). Other anatomical structures than the spine, such as the skull or pelvis for example, could also be segmented. The image segmentation (302) is used in treatment planning (304) as described above. The segmented VOI data from operation 303 is 3D transformed as described above in operation 310 and is used to generate “segmented” DRRs in operation 306 in each of the projections of the in-treatment imaging system. In operation 307, the DRRs are compared with in-treatment x-ray images acquired in operation 305 according to a fixed or adaptive treatment plan 304. As described above, the comparison may generate a similarity measure that is fed back to the 3D transformation of the VOI segmentation data to generate a new DRR in each projection. When the similarity measure is maximized (311), the current 3D transformation is selected and used for 3D-3D alignment (308) between the patient's pose in the radiation treatment system and the 3D coordinates of the 3D pre-treatment image.

FIG. 6B illustrates a method 400 in one embodiment showing how image segmentation may be used, in a radiation treatment system using pre-computed DRRs, to remove undesirable artifacts from 3D imaging data before DRR generation. In FIG. 6B, 3D imaging data is obtained in the conventional manner (e.g., CT, MRI, PET, 3DRA, etc.) in operation 401. In operation 402, the 3D imaging data is segmented to delineate a targeted pathological anatomy and critical anatomical structures for treatment planning purposes, as described above. In operation 403, a volume of interest (VOI) of the 3D imaging data is segmented for DRR generation, as described above. The image segmentation (402) is used in treatment planning (404) as described above. The segmented VOI data from operation 403 is 3D transformed through multiple 3D transformations covering an expected range of patient poses in the radiation treatment system (410). The multiple 3D transformations are used to generate multiple “segmented” DRRs in each projection of the in-treatment imaging system, as described above (406). In operation 412, an initial DRR is selected in each projection and compared with in-treatment x-ray images acquired in operation 405 according to a fixed or adaptive treatment plan 404. As described above, the comparison may generate a similarity measure that is fed back to the DRR selection operation 412 to select a new DRR in each projection. When a maximum similarity measure is (411), based on the best-matching DRRs, a 3D transformation may be interpolated or extrapolated from the preselected 3D transformations and used for 3D-3D alignment (408) between the patient's pose in the radiation treatment system and the 3D coordinates of the 3D pre-treatment image.

VOI segmentation defines a three-dimensional geometrical structure, in a patient's 3D pre-treatment image space (e.g., CT or other 3D image volume), to isolate an anatomical structure (such as the spine, for example) and, optionally, the region immediately surrounding the anatomical structure that can be used to generate DRR's without undesirable artifacts. A volume of interest may be represented in two formats, a geometrical representation that usually consists of a stack of parallel contours, or a volume representation that is essentially a binary mask volume as described below. The two formats are convertible, one to another. Volumes of interest may be stored in the geometrical format to save storage space.

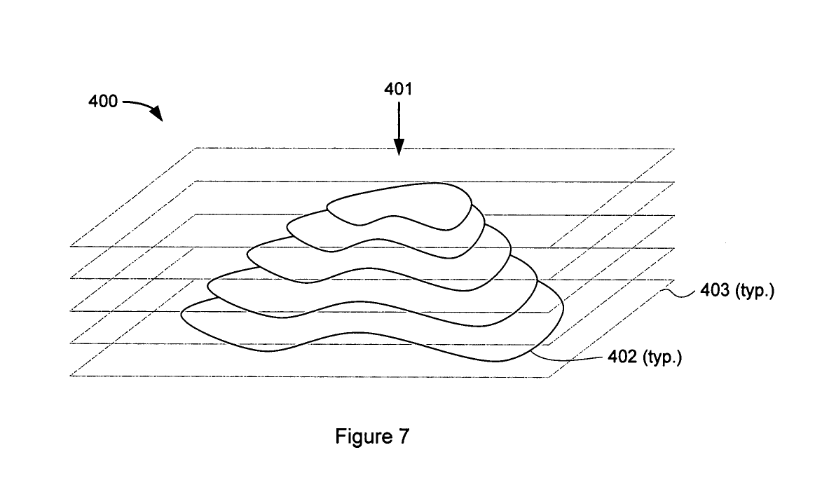

FIG. 7 illustrates a simplified geometrical representation of a CT image volume 400 containing a VOI 401 defined by a stack of contours 402. Each contour is defined on a corresponding plane 403 parallel to a slice of the CT image volume 400. A contour is usually represented as a set of points, which may be interpolated to obtain closed contours as illustrated in FIG. 7.

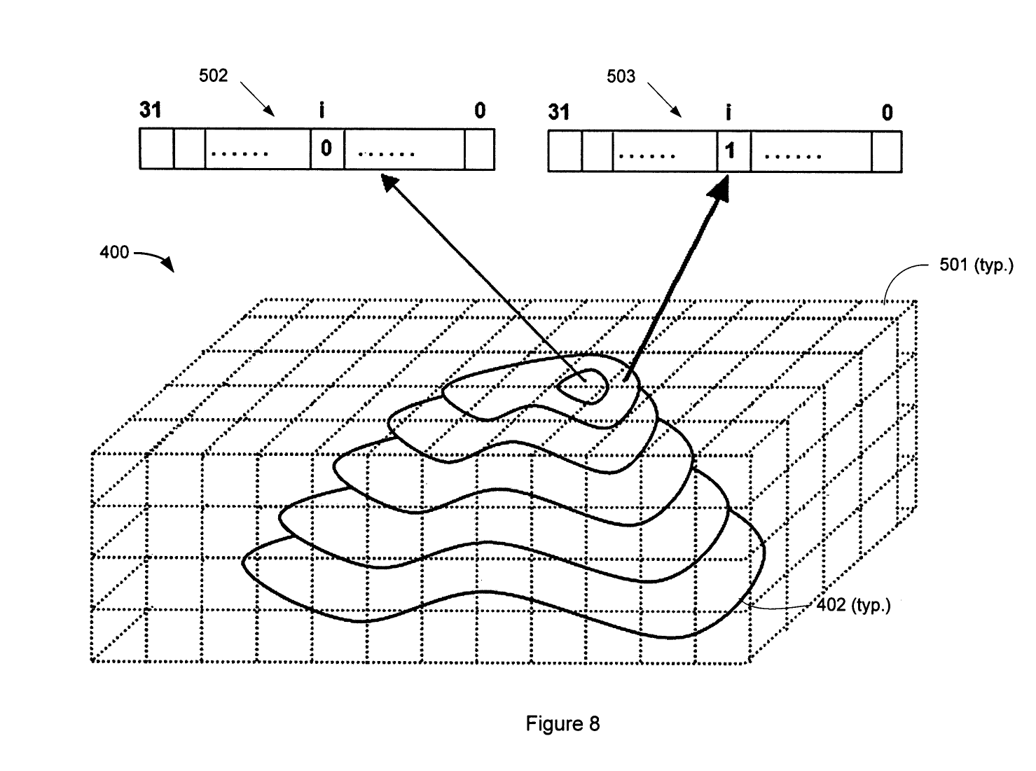

FIG. 8 illustrates how the geometric representation of VOI 401 of FIG. 7 may be converted to a volume representation of the VOI 401. In FIG. 8, the CT image volume 400 is divided into voxels (such as exemplary voxel 501) having the same resolution as the original CT imaging data. The voxels in the CT image volume 400 may be masked by a 3D binary mask (i.e., a mask for each voxel in the 3D CT image volume). The 3D binary mask may be defined as a one bit binary mask set having a one bit mask for each voxel in the CT image volume or as a multiple bit mask set having a multiple bit mask for each voxel in the CT image volume. A one bit binary mask can select or deselect voxels in the CT image volume to define a single VOI. For example, the single bit value may be set to 1 for voxels that lie inside the VOI defined by the contours 402 and 0 for voxels that lie outside of the VOI defined by the contours 402. A multiple bit mask allows multiple volumes of interest to be encoded in one 3D binary mask, with each bit corresponding to one VOI. For example, an 8-bit mask can represent 8 volumes of interest. A 32-bit mask, as illustrated by exemplary multiple bit masks 502 and 503 in FIG. 5 is capable of representing the state of its voxel (i.e., selected or deselected) in each of 32 different volumes of interest.

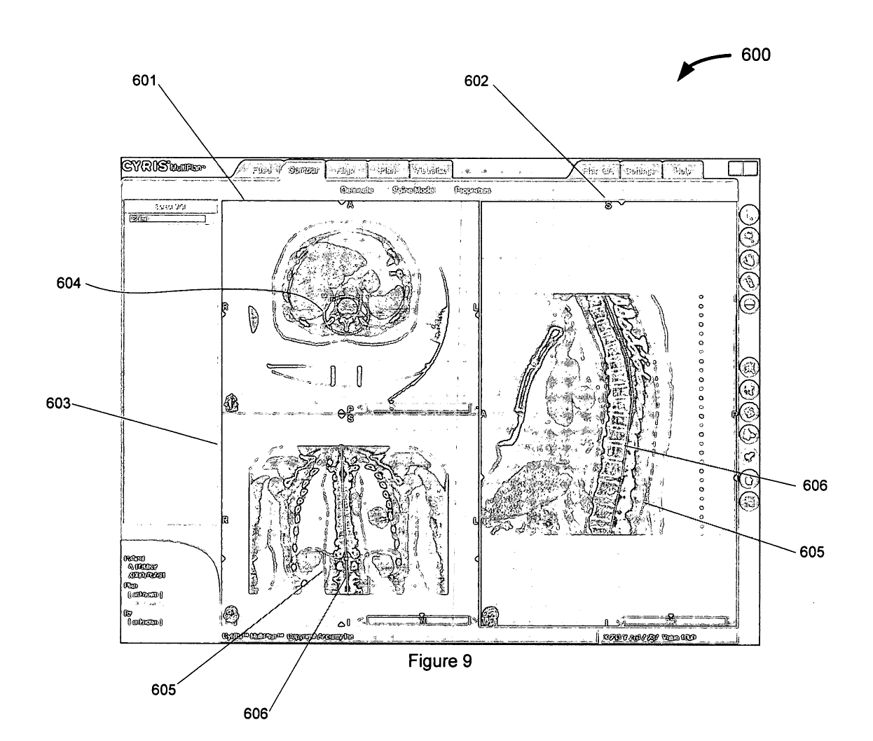

The process described above may be automated by a spine segmentation tool, such as the tool provided in the MultiPlan™ treatment planning system available from Accuray, Inc. of Sunnyvale, Calif. The segmentation tool may be used to manipulate a patient's medical image (e.g., CT or other image volume such as NMI, PET, etc.). FIG. 9 is a screenshot 600 illustrating how the segmentation tool allows a user to delineate a spine volume of interest simultaneously from three cutting planes of the medical image: the axial plane 601, the sagittal plane 602 and the coronal plane 603.

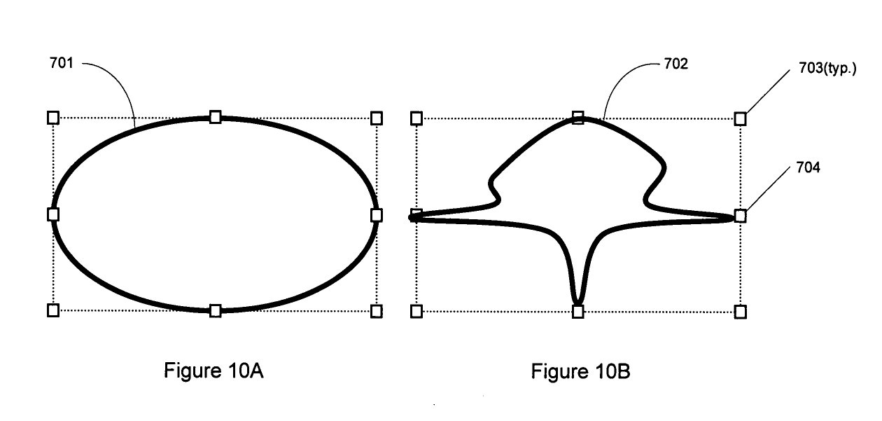

On the axial plane 601, a two-dimensional contour is displayed. The contour can be a solid contour when it is defined by a user, or it can be a dashed-line contour interpolated from adjacent contours by a computer. A user can modify the contour by resizing it, scaling it or moving it. A user can also modify the shape of the contour to match the actual spine on the image slice being displayed by tweaking a shape morphing parameter. The shape morphing parameter defines how close the contour is to an ellipse. When the shape morphing parameter is set to 0, for example, the contour may be a standard ellipse. When the shape morphing parameter is set to 1, the contour may assume the outline of a spinal bone using automatic edge recognition methods as described, for example, in copending U.S. patent application Ser. Nos. 10/880486 and 10/881208. By adjusting the morphing parameter in the range of [0, 1], the shape of the contour may be smoothly morphed from an ellipse 701, as illustrated in FIG. 10A, to a spinal bone 702, for example, as illustrated in FIG. 10B. A user can also adjust the shape of the contour 702, for example, using control points (such as control point 703) on the bounding box 704 of the contour 702.

On the sagittal plane 602 and coronal plane 603, a projected silhouette contour 605 of the spine volume of interest is displayed. The centers of all user defined contours (such as contour 604, for example) are connected as the central axis of the spine 606. A user can move, add or remove contours by moving or dragging the centers of the contours. When the center of a contour is moved on the sagittal or coronal planes, the actual contour defined on the axial image slice is moved accordingly. When the user selects any point in between two center points of adjacent axial contours, a new contour is added at that position, with the contour automatically set to the interpolation of the two adjacent axial contours. When a user drags and drops the center point of a contour outside the region of the two adjacent contours, or outside the image boundary, the contour is removed from the volume of interest. Once the spine volume of interest is delineated and stored in the geometrical format, it is converted to the volume format as a three-dimensional image volume containing only the voxels within the volume of interest.

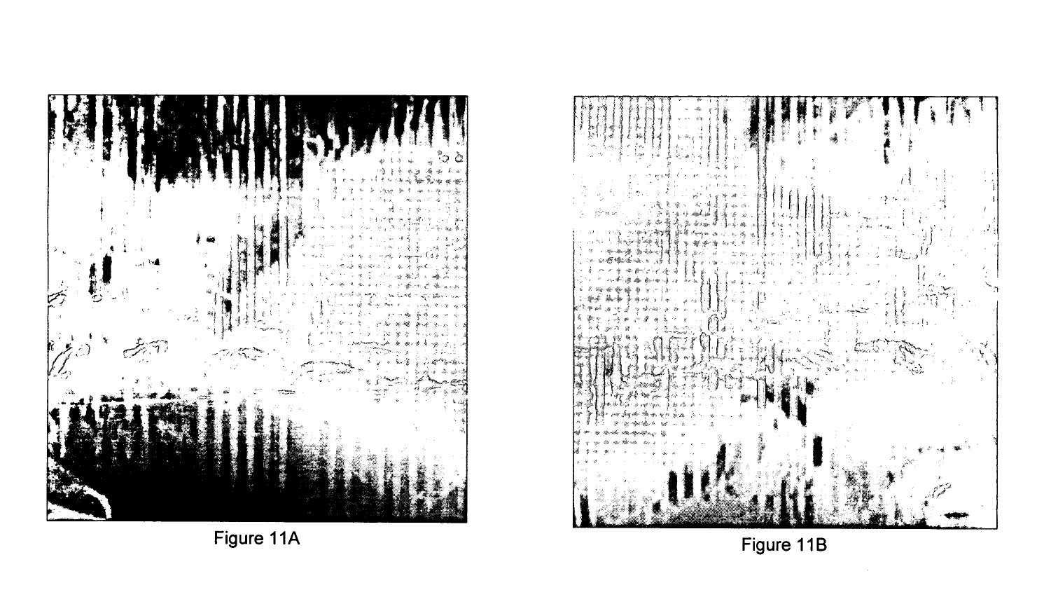

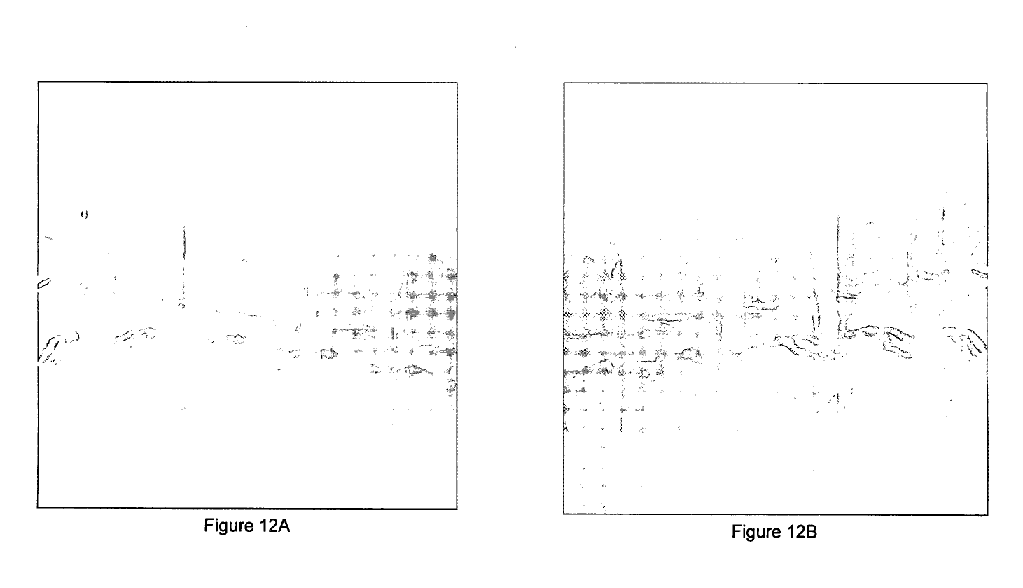

FIGS. 11A and 11B illustrate two orthogonally projected DRRs of the thoracic spine of a patient, obtained from unsegmented 3D imaging data in a CT image volume. It can be seen that both images exhibit severe image artifacts resulting from respiratory motion during CT image acquisition. FIGS. 12A and 12B illustrate the same two orthogonal projections represented by FIGS. 11A and 11B after spine segmentation is applied and image artifacts from bone and soft tissue outside the VOI have been removed.

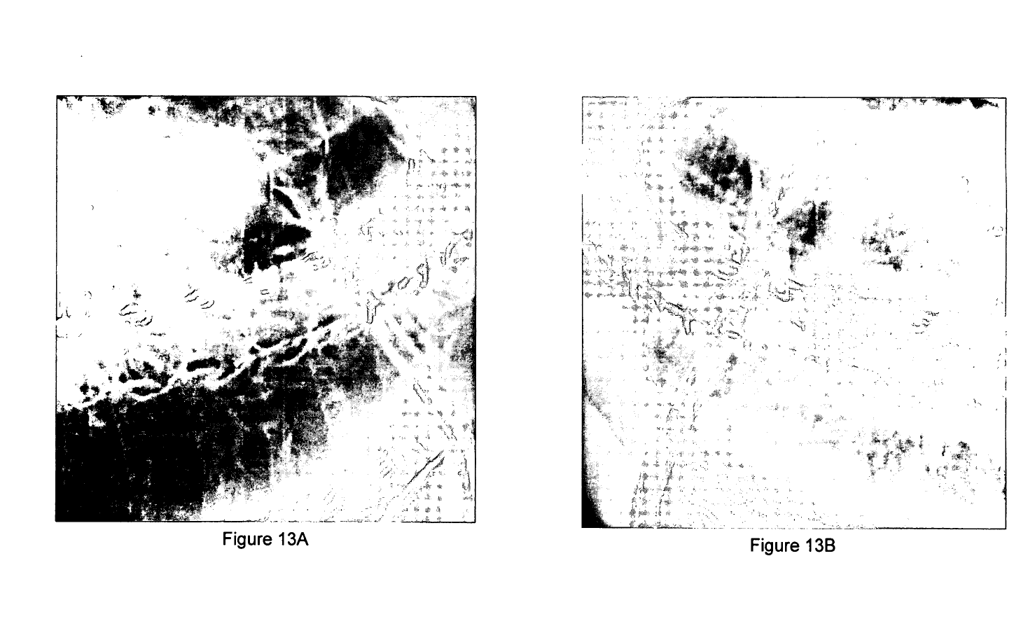

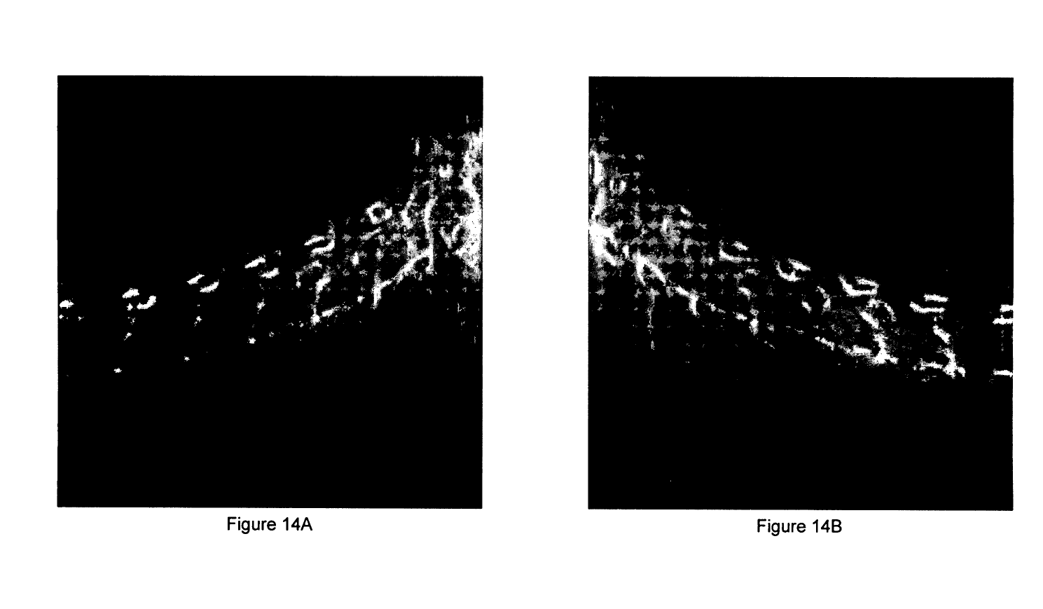

FIGS. 13A and 13B illustrate two orthogonally projected DRRs of the thoracic spine of a patient, obtained from unsegmented 3D imaging data in a CT image volume. It can be seen that both images exhibit interfering artifacts from bony structures and soft tissue. FIGS. 14A and 14B illustrate the same two orthogonal projections represented by FIGS. 13A and 13B after spine segmentation is applied and image artifacts from bone and soft tissue outside the VOI have been removed.

DRRs derived from segmented 3D imaging data may be compared with in-treatment x-rays during image-guided radiation treatment as described above to provide similarity measures that are more sensitive to small differences between the DRRs and the in-treatment x-ray images. As a result, registration between the DRRs and in-treatment x-rays is more accurate. In the case of non-rigid structures, such as the spine, more accurate registration may be manifested in improved accuracy of 2D displacement fields in each projection of the in-treatment imaging system that describe the vector displacement, at each point in the imaging field of view, between the DRR and the in-treatment x-ray. The displacement fields in each projection may then be combined and averaged to determine an average rigid transformation as described in U.S. patent application Ser. Nos. 10/880486 and 10/881208 (2D displacement fields may be treated as a type of similarity measure for the registration of non-rigid structures).

Once a rigid transformation is obtained, the patient's pose in the radiation treatment system may be aligned with the coordinates of the 3D pretreatment image, the coordinates of a targeted pathological anatomy (as derived from treatment planning, for example) may be located, and radiation treatment maybe applied to the pathological anatomy.

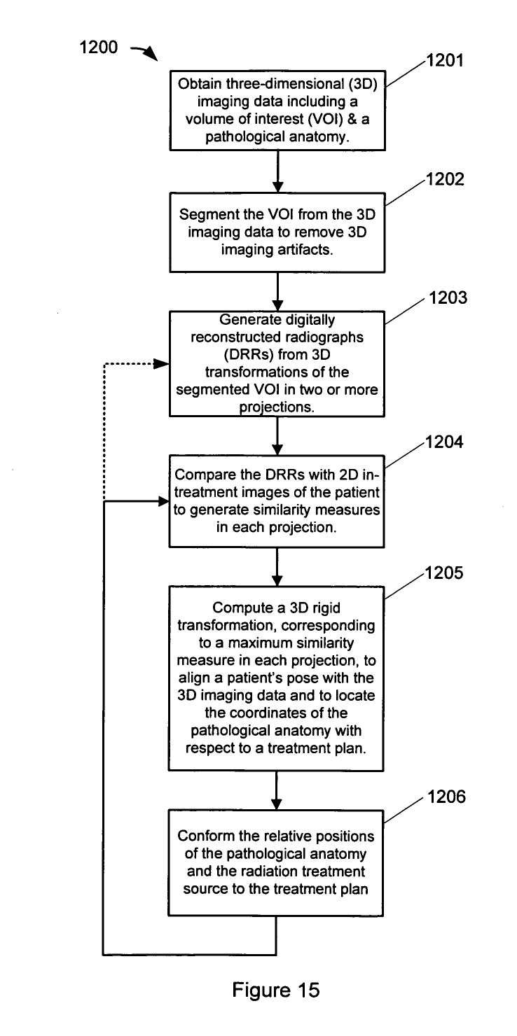

Thus, a method of VOI segmentation for DRR generation and image registration has been described. In one embodiment, as illustrated in FIG. 15, a method 1200 includes: obtaining 3D imaging data including a volume of interest (VOI) and a pathological anatomy (operation 1201); segmenting the volume of interest from the 3D imaging data to remove imaging artifacts (operation 1202); generating digitally reconstructed radiographs (DRRs) from 3D transformations of the segmented VOI in two or more projections (operation 1203); comparing the DRRs with 2D in-treatment images of a patient to generate similarity measures in each projection (operation 1204); computing a 3D rigid transformation, corresponding to a maximum similarity measure in each projection, to align a patient's pose with the 3D imaging data and to locate the coordinates of the pathological anatomy with respect to a treatment plan (operation 1205); and conform relative positions of the pathological anatomy and the radiation treatment source to the treatment plan (operation 1206). As illustrated in FIG. 15, operations 1204 through 1206 (or optionally 1203 through 1206 as described above) may be iterated to constantly correct for any patient movement during the radiation treatment session.

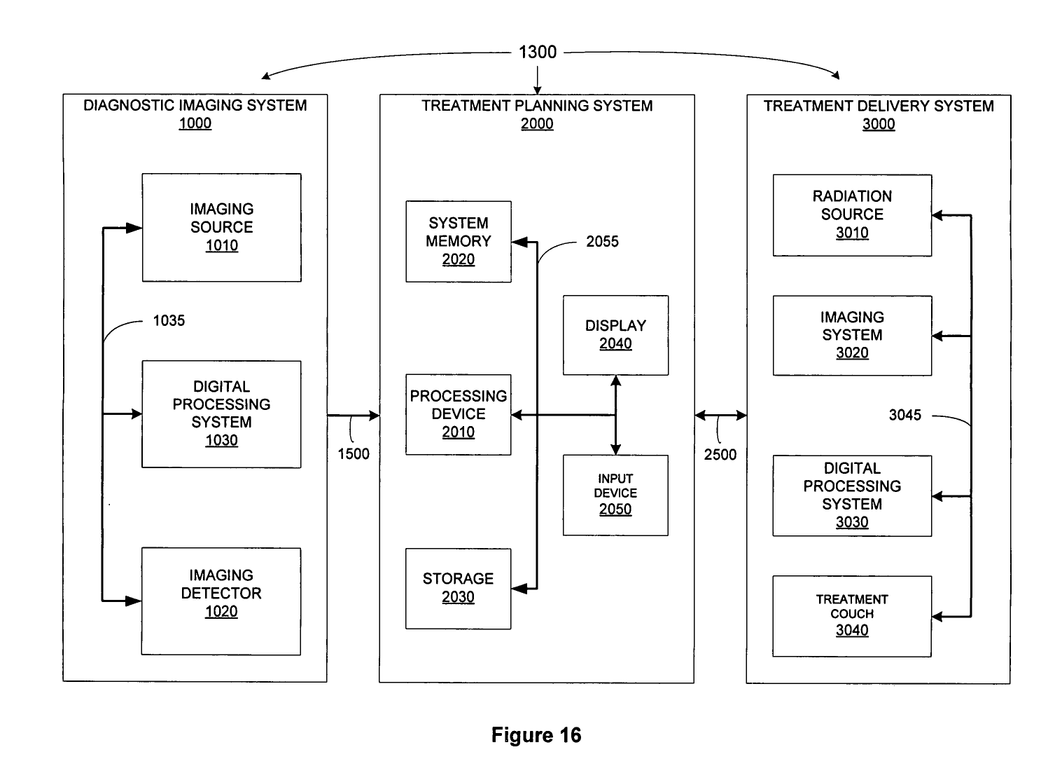

FIG. 16 illustrates one embodiment of systems 1300 that may be used in performing radiation treatment in which features of the present invention may be implemented. As described below and illustrated in FIG. 13, system 1300 may include a diagnostic imaging system 1000, a treatment planning system 2000 and a treatment delivery system 3000.

Diagnostic imaging system 1000 may be any system capable of producing medical diagnostic images of a patient that may be used for subsequent medical diagnosis, treatment planning and/or treatment delivery. For example, diagnostic imaging system 1000 may be a computed tomography (CT) system, a magnetic resonance imaging (MRI) system, a positron emission tomography (PET) system, an ultrasound system or the like. For ease of discussion, diagnostic imaging system 1000 may be discussed below at times in relation to a CT imaging modality. However, other imaging modalities such as those above may also be used.

Diagnostic imaging system 1000 includes an imaging source 1010 to generate an imaging beam (e.g., x-rays, ultrasonic waves, radio frequency waves, etc.) and an imaging detector 1020 to detect and receive the beam generated by imaging source 1010, or a secondary beam or emission stimulated by the beam from the imaging source (e.g., in an MRI or PET scan).

The imaging source 1010 and the imaging detector 1020 may be coupled to a digital processing system 1030 to control the imaging operation and process image data. Diagnostic imaging system 1000 includes a bus or other means 1035 for transferring data and commands among digital processing system 1030, imaging source 1010 and imaging detector 1020. Digital processing system 1030 may include one or more general-purpose processors (e.g., a microprocessor), special purpose processor such as a digital signal processor (DSP) or other type of device such as a controller or field programmable gate array (FPGA). Digital processing system 1030 may also include other components (not shown) such as memory, storage devices, network adapters and the like. Digital processing system 1030 may be configured to generate digital diagnostic images in a standard format, such as the DICOM (Digital Imaging and Communications in Medicine) format, for example. In other embodiments, digital processing system 1030 may generate other standard or non-standard digital image formats. Digital processing system 1030 may transmit diagnostic image files (e.g., the aforementioned DICOM formatted files) to treatment planning system 2000 over a data link 1500, which may be, for example, a direct link, a local area network (LAN) link or a wide area network (WAN) link such as the Internet. In addition, the information transferred between systems may either be pulled or pushed across the communication medium connecting the systems, such as in a remote diagnosis or treatment planning configuration. In remote diagnosis or treatment planning, a user may utilize embodiments of the present invention to diagnose or treatment plan despite the existence of a physical separation between the system user and the patient.

Treatment planning system 2000 includes a processing device 2010 to receive and process image data. Processing device 2010 may represent one or more general-purpose processors (e.g., a microprocessor), special purpose processor such as a digital signal processor (DSP) or other type of device such as a controller or field programmable gate array (FPGA). Processing device 2010 may be configured to execute instructions for performing treatment planning and/or image processing operations discussed herein, such as the spine segmentation tool described herein.

Treatment planning system 2000 may also include system memory 2020 that may include a random access memory (RAM), or other dynamic storage devices, coupled to processing device 2010 by bus 2055, for storing information and instructions to be executed by processing device 2010. System memory 2020 also may be used for storing temporary variables or other intermediate information during execution of instructions by processing device 2010. System memory 2020 may also include a read only memory (ROM) and/or other static storage device coupled to bus 2055 for storing static information and instructions for processing device 2010.

Treatment planning system 2000 may also include storage device 2030, representing one or more storage devices (e.g., a magnetic disk drive or optical disk drive) coupled to bus 2055 for storing information and instructions. Storage device 2030 may be used for storing instructions for performing the treatment planning steps discussed herein and/or for storing 3D imaging data and DRRs as discussed herein.

Processing device 2010 may also be coupled to a display device 2040, such as a cathode ray tube (CRT) or liquid crystal display (LCD), for displaying information (e.g., a 2D or 3D representation of the VOI) to the user. An input device 2050, such as a keyboard, may be coupled to processing device 2010 for communicating information and/or command selections to processing device 2010. One or more other user input devices (e.g., a mouse, a trackball or cursor direction keys) may also be used to communicate directional information, to select commands for processing device 2010 and to control cursor movements on display 2040.

It will be appreciated that treatment planning system 2000 represents only one example of a treatment planning system, which may have many different configurations and architectures, which may include more components or fewer components than treatment planning system 2000 and which may be employed with the present invention. For example, some systems often have multiple buses, such as a peripheral bus, a dedicated cache bus, etc. The treatment planning system 2000 may also include MIEUT (Medical Image Review and Import Tool) to support DICOM import (so images can be fused and targets delineated on different systems and then imported into the treatment planning system for planning and dose calculations), expanded image fusion capabilities that allow the user to treatment plan and view dose distributions on any one of various imaging modalities (e.g., MRI, CT, PET, etc.). Treatment planning systems are known in the art; accordingly, a more detailed discussion is not provided.

Treatment planning system 2000 may share its database (e.g., data stored in storage device 2030) with a treatment delivery system, such as treatment delivery system 3000, so that it may not be necessary to export from the treatment planning system prior to treatment delivery. Treatment planning system 2000 may be linked to treatment delivery system 3000 via a data link 2500, which may be a direct link, a LAN link or a WAN link as discussed above with respect to data link 1500. It should be noted that when data links 1500 and 2500 are implemented as LAN or WAN connections, any of diagnostic imaging system 1000, treatment planning system 2000 and/or treatment delivery system 3000 may be in decentralized locations such that the systems may be physically remote from each other. Alternatively, any of diagnostic imaging system 1000, treatment planning system 2000 and/or treatment delivery system 3000 may be integrated with each other in one or more systems.

Treatment delivery system 3000 includes a therapeutic and/or surgical radiation source 3010 to administer a prescribed radiation dose to a target volume in conformance with a treatment plan. Treatment delivery system 3000 may also include an imaging system 3020 to capture intra-treatment images of a patient volume (including the target volume) for registration or correlation with the diagnostic images described above in order to position the patient with respect to the radiation source. Imaging system 3020 may include any of the imaging systems described above. Treatment delivery system 3000 may also include a digital processing system 3030 to control radiation source 3010, imaging system 3020 and a patient support device such as a treatment couch 3040. Digital processing system 3030 may be configured to register 2D radiographic images from imaging system 3020, from two or more stereoscopic projections, with digitally reconstructed radiographs (e.g., DRRs from segmented 3D imaging data) generated by digital processing system 1030 in diagnostic imaging system 1000 and/or DRRs generated by processing device 2010 in treatment planning system 2000. Digital processing system 3030 may include one or more general-purpose processors (e.g., a microprocessor), special purpose processor such as a digital signal processor (DSP) or other type of device such as a controller or field programmable gate array (FPGA). Digital processing system 3030 may also include other components (not shown) such as memory, storage devices, network adapters and the like. Digital processing system 3030 may be coupled to radiation source 3010, imaging system 3020 and treatment couch 3040 by a bus 3045 or other type of control and communication interface.

Digital processing system 3030 may implement methods (e.g., such as method 1200 described above) to register images obtained from imaging system 3020 with pre-operative treatment planning images in order to align the patient on the treatment couch 3040 within the treatment delivery system 3000, and to precisely position the radiation source with respect to the target volume.

The treatment couch 3040 may be coupled to another robotic arm (not illustrated) having multiple (e.g., 5 or more) degrees of freedom. The couch arm may have five rotational degrees of freedom and one substantially vertical, linear degree of freedom. Alternatively, the couch arm may have six rotational degrees of freedom and one substantially vertical, linear degree of freedom or at least four rotational degrees of freedom. The couch arm may be vertically mounted to a column or wall, or horizontally mounted to pedestal, floor, or ceiling. Alternatively, the treatment couch 3040 may be a component of another mechanical mechanism, such as the Axum® treatment couch developed by Accuray, Inc. of California, or be another type of conventional treatment table known to those of ordinary skill in the art.

It should be noted that the methods and apparatus described herein are not limited to use only with medical diagnostic imaging and treatment. In alternative embodiments, the methods and apparatus herein may be used in applications outside of the medical technology field, such as industrial imaging and non-destructive testing of materials (e.g., motor blocks in the automotive industry, airframes in the aviation industry, welds in the construction industry and drill cores in the petroleum industry) and seismic surveying. In such applications, for example, “treatment” may refer generally to the application of radiation beam(s).

It will be apparent from the foregoing description that aspects of the present invention may be embodied, at least in part, in software. That is, the techniques may be carried out in a computer system or other data processing system in response to its processor, such as processing device 2010, for example, executing sequences of instructions contained in a memory, such as system memory 2020, for example. In various embodiments, hardware circuitry may be used in combination with software instructions to implement the present invention. Thus, the techniques are not limited to any specific combination of hardware circuitry and software or to any particular source for the instructions executed by the data processing system. In addition, throughout this description, various functions and operations may be described as being performed by or caused by software code to simplify description. However, those skilled in the art will recognize what is meant by such expressions is that the functions result from execution of the code by a processor or controller, such as processing device 2010.

A machine-readable medium can be used to store software and data which when executed by a data processing system causes the system to perform various methods of the present invention. This executable software and data may be stored in various places including, for example, system memory 2020 and storage 2030 or any other device that is capable of storing software programs and/or data.

Thus, a machine-readable medium includes any mechanism that provides (i.e., stores and/or transmits) information in a form accessible by a machine (e.g., a computer, network device, personal digital assistant, manufacturing tool, any device with a set of one or more processors, etc.). For example, a machine-readable medium includes recordable/non-recordable media (e.g., read only memory (ROM); random access memory (RAM); magnetic disk storage media; optical storage media; flash memory devices; etc.), as well as electrical, optical, acoustical or other forms of propagated signals (e.g., carrier waves, infrared signals, digital signals, etc.); etc.

It should be appreciated that references throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention. In addition, while the invention has been described in terms of several embodiments, those skilled in the art will recognize that the invention is not limited to the embodiments described. The embodiments of the invention can be practiced with modification and alteration within the scope of the appended claims. The specification and the drawings are thus to be regarded as illustrative instead of limiting on the invention.

What is claimed is:

1. A method, comprising:
segmenting a volume of interest (VOI) from three-dimensional (3D) imaging data to obtain a segmented VOI, wherein the 3D imaging data includes a pathological anatomy; and
generating digitally reconstructed radiographs (DRRs) from 3D transformations of the segmented VOI in each of two or more projections.

2. The method of claim 1, further comprising:
comparing a DRR in each projection with a corresponding two-dimensional (2D) in-treatment image to produce a similarity measure in each projection; and
computing a 3D rigid transformation corresponding to a maximum similarity measure in each projection.

3. The method of claim 2, wherein the maximum similarity measure corresponds to registration between the DRR in each projection and the corresponding 2D in-treatment image, further comprising computing the 3D rigid transformation from a transformation between the DRR in each projection and the corresponding 2D in-treatment image.

4. The method of claim 2, wherein the similarity measure in each projection comprises a vector displacement field between the DRR and the corresponding 2D in-treatment image.

5. The method of claim 4, further comprising determining an average rigid transformation of the segmented VOI from the 2D displacement field in each projection.

6. The method of claim 5, further comprising:
conforming relative positions of the pathological anatomy and a radiation treatment source to a radiation treatment plan.

7. The method of claim 2, wherein computing the 3D rigid transformation comprises:
computing a similarity measure between a first DRR in each projection and a corresponding 2D in-treatment image; and
selecting a transformation of the 3D segmented region from the similarity measure that generates a second DRR in each projection having an increased similarity measure with the corresponding 2D in-treatment image.

8. The method of claim 7, further comprising:
selecting a transformation of the 3D segmented region data that produces the greatest similarity measure in each projection.

9. The method of claim 2, wherein computing the 3D rigid transformation comprises:
computing a similarity measure between each of a plurality of DRRs in each projection and a corresponding 2D in-treatment image, wherein each DRR in a projection corresponds to a different 3D transformation of the segmented VOI.

10. The method of claim 9, further comprising:
selecting a transformation of the segmented VOI that produces the greatest similarity measure in each projection.

11. The method of claim 10, further comprising
determining 3D coordinates of the pathological anatomy from the transformation of the segmented VOI that produces the greatest similarity measure in each projection.

12. The method of claim 11, further comprising:
positioning a radiation treatment beam source using the 3D coordinates of the pathological anatomy such that a radiation beam emitted from the radiation treatment beam source is focused onto the pathological anatomy.

13. The method of claim 11, further comprising:
positioning a patient using the 3D coordinates of the pathological anatomy such that a radiation beam emitted from a radiation treatment beam source is focused onto the pathological anatomy.

14. The method of claim 1, wherein the VOI comprises a set of 2D contours in one or more views of the 3D imaging data.

15. The method of claim 1, wherein segmenting the VOI comprises generating a 3D voxel mask, wherein the voxel mask is configured to delineate the segmented region and to exclude all anatomical structures external to the segmented region.

16. The method of claim 15, wherein the 3D voxel mask is generated from a set of 2D contours.

17. The method of claim 15, wherein the 3D voxel mask comprises a plurality of multiple-bit voxel masks, wherein each bit in a multiple-bit voxel mask corresponds to a different VOI.

18. The method of claim 1, further comprising obtaining the 3D imaging data from a medical imaging system.

19. The method of claim 1, wherein the 3D imaging data comprises one or more of computed tomography (CT) image data, magnetic resonance (MR) image data, positron emission tomography (PET) image data and 3D rotational angiography (3DRA) image data for treatment planning.

20. The method of claim 1, wherein the 3D segmented region is the spine.

21. The method of claim 1, wherein the 3D segmented region is the cranium.

22. The method of claim 1, wherein the corresponding two-dimensional (2D) in-treatment image comprises an in-treatment x-ray image.

23. An article of manufacturing, comprising:
a machine-accessible medium including data that, when accessed by a machine, cause the machine to perform operations comprising:
segmenting a volume of interest (VOI) from three-dimensional (3D) imaging data to obtain a segmented VOI, wherein the 3D imaging data includes a pathological anatomy; and
generating digitally reconstructed radiographs (DRRs) from 3D transformations of the segmented VOI in each of two or more projections.

24. The article of manufacture of claim 23, wherein the machine-accessible medium further includes data that cause the machine to perform operations, comprising:
comparing a DRR in each projection with a corresponding two-dimensional (2D) in-treatment image to produce a similarity measure in each projection; and
computing a 3D rigid transformation corresponding to a maximum similarity measure in each projection.

25. The article of manufacture of claim 24, wherein the maximum similarity measure corresponds to registration between the DRR in each projection and the corresponding 2D in-treatment image, further comprising computing the 3D rigid transformation from a transformation between the DRR in each projection and the corresponding 2D in-treatment image.

26. The article of manufacture claim 24, wherein the transformation between the DRR and the corresponding 2D in-treatment image is a 2D displacement field in each projection.

27. The article of manufacture claim 26, wherein the machine-accessible medium further includes data that cause the machine to perform operations, comprising:
determining an average rigid transformation of the segmented VOI from the 2D displacement field in each projection.

28. The article of manufacture of claim 27, wherein the machine-accessible medium further includes data that cause the machine to perform operations, comprising:
conforming relative positions of the pathological anatomy and a radiation treatment source to a radiation treatment plan.

29. The article of manufacture of claim 24, wherein computing the 3D rigid transformation comprises:
computing a similarity measure between a first DRR in each projection and a corresponding 2D in-treatment image; and
selecting a transformation of the 3D segmented region from the similarity measure that generates a second DRR in each projection having an increased similarity measure with the corresponding 2D in-treatment image.

30. The article of manufacture of claim 29, wherein the machine-accessible medium further includes data that cause the machine to perform operations, comprising:
selecting a transformation of the 3D segmented region data that produces the greatest similarity measure in each projection.

31. The article of manufacture of claim 24, wherein the machine-accessible medium further includes data that cause the machine to perform operations, comprising:
computing a similarity measure between each of a plurality of DRRs in each projection and a corresponding 2D in-treatment image, wherein each DRR in a projection corresponds to a different 3D transformation of the segmented VOI.

32. The article of manufacture of claim 31, wherein the machine-accessible medium further includes data that cause the machine to perform operations, comprising:
selecting a transformation of the segmented VOI that produces the greatest similarity measure in each projection.

33. The article of manufacture of claim 32, wherein the machine-accessible medium further includes data that cause the machine to perform operations, comprising:
determining 3D coordinates of the pathological anatomy from the transformation of the segmented VOI that produces the greatest similarity measure in each projection.

34. The article of manufacture of claim 33, wherein the machine-accessible medium further includes data that cause the machine to perform operations, comprising:
positioning a radiation treatment beam source using the 3D coordinates of the pathological anatomy such that a radiation beam emitted from the radiation treatment beam source is focused onto the pathological anatomy.

35. The article of manufacture of claim 33, wherein the machine-accessible medium further includes data that cause the machine to perform operations, comprising:
positioning a patient using the 3D coordinates of the pathological anatomy such that a radiation beam emitted from a radiation treatment beam source is focused onto the pathological anatomy.

36. The article of manufacture of claim 23, wherein the segmented VOI comprises a set of 2D contours in one or more views of the 3D imaging data.

37. The article of manufacture of claim 23, wherein segmenting the VOI comprises generating a 3D voxel mask, wherein the voxel mask is configured to delineate the VOI and to exclude all anatomical structures external to the VOI.

38. The article of manufacture of claim 37, wherein the 3D voxel mask is generated from a set of 2D contours.

39. The article of manufacture of claim 37, wherein the 3D voxel mask comprises a plurality of multiple-bit voxel masks, wherein each bit in a multiple-bit voxel mask corresponds to a different VOI.

40. The article of manufacture of claim 23, wherein the machine-accessible medium further includes data that cause the machine to perform operations, comprising obtaining the 3D imaging data from a medical imaging system.

41. The article of manufacture of claim 23, wherein the 3D imaging data comprises one or more of computed tomography (CT) image data, magnetic resonance (MR) image data, positron emission tomography (PET) image data and 3D rotational angiography (3DRA) image data for treatment planning.

42. The article of manufacture of claim 23, wherein the 3D segmented region is the spine.

43. The article of manufacture of claim 23, wherein the 3D segmented region is the cranium.

44. The article of manufacture of claim 23, wherein the corresponding two-dimensional (2D) in-treatment image comprises an in-treatment x-ray image.

45. A system, comprising:
a treatment planning system including a first processing device, wherein the first processing device is configured to segment a volume of interest (VOI) from three-dimensional (3D) scan data to obtain a segmented VOI, wherein the 3D imaging data includes a pathological anatomy, and wherein the first processing device is further configured to generate a plurality of digitally reconstructed radiographs (DRRs) from the segmented VOI in each of two or more projections; and
a treatment delivery system including a second processing device configured to compare one or more DRRs in each projection with a corresponding two-dimensional (2D) in-treatment image to generate a 2D displacement field in each projection.

46. The system of claim 45, further comprising an image acquisition system including a third processing device, wherein the third processing device is configured to obtain the 3D imaging data, and wherein the second processor is further configured to determine an average rigid transformation of the 3D image data and a 3D displacement of the pathological anatomy and to apply image-guided radiation treatment to the pathological anatomy.

47. The system of claim 46, wherein the first processing device, the second processing device and the third processing device are the same processing device.

48. The system of claim 46, wherein the first processing device, the second processing device and the third processing device are different processing devices.

49. An apparatus, comprising:
means for removing image artifacts from an imaged volume; and
means for generating a two-dimensional (2D) projection of the imaged volume without the image artifacts.

50. The apparatus of claim 49, wherein the image artifacts are motion artifacts.

51. The apparatus of claim 49, wherein the image artifacts are interference artifacts.

52. The apparatus of claim 49, further comprising means for registering the 2D projection of the imaged volume with a corresponding 2D in-treatment image to determine 2D-3D transformation between the 2D in-treatment image and the imaged volume.

53. The apparatus of claim 49, further comprising means for comparing the 2D projection of the imaged volume with a corresponding 2D in-treatment image to generate a similarity measure, wherein the similarity measure corresponds to a 3D transformation of the imaged volume.
